(19) United States
(12) Patent Application Publication
(10) Pub. No.: US 2020/0009472 A1
(43) Pub. Date: Jan. 9, 2020

(54) Disposal System for Unused Pharmaceuticals

(71) Applicant: Insys Development Company, Inc., Chandler, AZ (US)

(72) Inventors: Ashok Jagannath Chavan, Chandler, AZ (US); Rakeshkumar Joshi, Chandler, AZ (US); Scott Newton Crisman, Mesa, AZ (US); Patrick Karchung Kwan, Phoenix, AZ (US)

(21) Appl. No.: 16/578,244

(22) Filed: Sep. 20, 2019

Related U.S. Application Data
(63) Continuation of application No. 15/174,286, filed on Jun. 6, 2016, now abandoned.
(60) Provisional application No. 62/174,546, filed on Jun. 12, 2015.

(51) Int. Cl. B01D 15/00; B65B 7/28

(52) U.S. Cl. CPC B01D 15/00; B65B 7/28

(57) ABSTRACT

The present invention is directed to a disposal system for unused pharmaceuticals comprised of a container and bentonite clay affixed to one or more substrates. Further the present invention is directed to a disposal system for unused portions of a liquid fentanyl spray comprising a container and bentonite clay affixed to one or more substrates.

### BACKGROUND OF THE INVENTION

Unused pharmaceuticals are a serious hazard in modern society. Many pharmaceuticals are prescribed in quantities greater than that needed to treat the patient. For example, narcotics are often prescribed to relieve pain without an ability to determine when the pain will subside. The patient will often dispose of the unused narcotics by placing them in a household or business garbage receptacle where they can accidently be ingested by children or purposefully abused by an addict. Alternatively, the patient may flush the unused narcotics down the toilet where they enter the water stream. The narcotics are then continuously ingested by the public due to the fact that municipal water treatment plants are inadequate to rid the drinking water supply of pharmaceutical contaminants.

There are a handful of attempted solutions to the problem of unused pharmaceuticals. One attempted solution is known by the trade mark Deterra® marketed by Verde Technologies, Inc. Deterra® is a pouch of activated carbon described and claimed in U.S. Pat. No. 8,535,711 to Anderson et al. Yet another attempted solution is known by the name the Pill Catcher™ marketed by The Pill Catcher Family. The Pill Catcher™ is a plastic container with a screw top lid containing bentonite clay powder or grain to which water must be added prior to insertion of the pharmaceutical drug and is described and claimed in U.S. Pat. No. 7,918,777 to Parrott. U.S. Pat. No. 8,523,752 to Neal describes and claims a method of disposing of pharmaceutical waste including the combination of 1 part powdered bentonite clay and 3 parts sawdust combined with a volume of liquid. These attempted solutions all use either activated carbon or bentonite clay as an adsorbing or absorbing agent to sequester the pharmaceutical.

Bentonite clay comes in many forms based on the major element of its composition. Some forms of bentonite clay include potassium, sodium, calcium and aluminum with sodium and calcium being the most commonly used in industry. Sodium bentonite is used as an absorbent because it swells when contacted with water resulting in the ability to absorb several times its weight. Calcium bentonite is used as an adsorbent that can adhere ions, fats and oils. Bentonite has many industrial uses including use as a binder, purifier, absorbent and ground water barrier. The most common use of bentonite is as a drilling mud to aid in drilling bore holes in the earth. Despite the common use of bentonite clay there are regions in which bentonite is not readily available. Further, bentonite clay is not a readily renewable resource.

Thus, there is a need in the art of drug disposal for a disposal system using reduced amounts of bentonite clay.

### SUMMARY OF THE INVENTION

It has been discovered that absorption by bentonite clay affixed to one or more substrates is effective to inhibit extraction of pharmaceuticals. The attachment of bentonite clay to a substrate allows for a reduced amount of clay to be used. The present invention is directed to a disposal system for unused pharmaceuticals which may comprise, consist essentially of or consist of a container with an opening and a closure to seal the opening and a bentonite disposed in the container wherein the bentonite is affixed to one or more substrates.

In a preferred embodiment of the disposal system of the present invention the bentonite clay used in the disposal system of the present invention contains sodium as the most abundant chemical ion.

In another preferred embodiment of the disposal system of the present invention sawdust is not disposed in the container.

In another preferred embodiment of the disposal system of the present invention the one or more substrates are permeable to water and ethanol.

In a more preferred embodiment of the disposal system of the present invention the bentonite clay is fixed to one substrate.

In another more preferred embodiment of the disposal system of the present invention the bentonite clay is fixed between a first substrate and a second substrate.

In yet a more preferred embodiment the present invention is directed to a disposal system for unused portions of a liquid fentanyl spray which may comprise, consist essentially of or consist of a container with an opening and a closure to seal the opening and a bentonite clay comprising sodium bentonite, wherein the bentonite clay is fixed between two water and ethanol permeable substrates.

In an even more preferred embodiment of the disposal system for unused portions of a liquid fentanyl spray sawdust is not disposed in the container.

In another embodiment, the present invention is directed to a method of disposing of unused portions of a liquid fentanyl spray comprising the steps of:
(i) actuating the liquid fentanyl spray device wherein the spray stream passes through the opening of a container and contacts bentonite clay disposed in the container; and
(ii) occluding the opening of the container with a closure, wherein the bentonite clay is affixed to one or more substrates.

In a preferred embodiment the bentonite clay used in the methods of the present invention contains sodium as the most abundant chemical ion.

In another preferred embodiment of the methods of the present invention sawdust is not disposed in the container.

In another preferred embodiment of the methods of the present invention the one or more substrates are permeable to water and ethanol.

In a more preferred embodiment of the methods of the present invention the bentonite clay is fixed to one substrate.

In another more preferred embodiment of the methods of the present invention the bentonite clay is fixed between a first substrate and a second substrate.

### BRIEF DESCRIPTION OF THE DRAWINGS

FIG. 1. A container for disposal of unused pharmaceuticals.

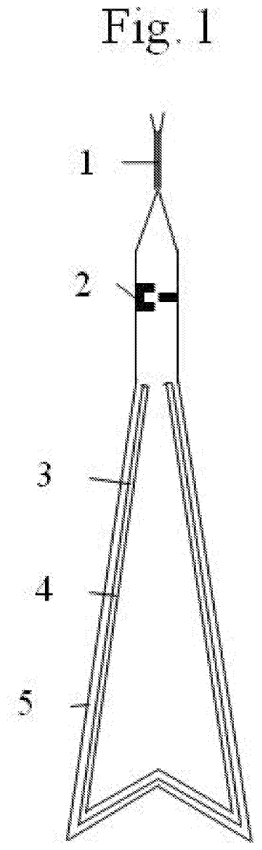

### DETAILED DESCRIPTION OF THE INVENTION

The present invention is directed to a disposal system for unused pharmaceuticals which may comprise, consist essentially of or consist of a container with an opening and a closure for the opening and bentonite clay affixed to one or more substrates.

### Definitions

As used herein the term “container” refers to any receptacle capable of holding any amount of bentonite clay and receiving any amount of unused pharmaceuticals. Non-limiting examples of containers include bottles, jugs, pouches and cans which may be constructed of any pliable or non-pliable material including, but not limited to, paper, textile, glass, plastic, rubber, and metal.

As used herein the term “opening” refers to any negative space in the surface of a container that allows entry of unused pharmaceuticals. The opening of the container of the present invention may be readily apparent or unapparent depending on the closure used.

As used herein the term “closure” refers to any structure capable of occluding the opening of the container. The closure may be continuous with the container itself or a separate structure. Non-limiting examples of closures include a flap, a cap, a plug, a lid, a tongue and groove seal, and a zipper. Closures of the present invention may be constructed of any pliable or non-pliable material including, but not limited to, paper, textile, glass, plastic, rubber, and metal. Closures of the present invention may occlude the opening of the container by interacting with the container via friction, adhesion, cohesion, covalent bonds, van der Waals force or any other form of bonding. The interaction of the closure and container may be aided by the use of an adhesive substance.

As used herein the term “bentonite” or “bentonite clay” refers to a naturally occurring colloidal clay or volcanic ash. Bentonite clay of the present invention may have as its majority chemical ion either sodium or calcium. Bentonite clay may be in various states of purity and include other substances that either occur naturally in the bentonite clay or are added.

As used herein the term “substrate” refers to any material to which bentonite clay may be affixed. The container may be composed entirely or partially of the substrate to which the bentonite clay is affixed.

As used herein the term “affixed” or “fixed” refers to any method capable of attaching bentonite clay to a substrate. Common methods used to affix bentonite clay to a substrate include stitchbonding, needlepunched fibers, adhesive and combinations thereof. The adhesive may be placed between the bentonite clay and the substrate or mixed into the bentonite clay.

As used herein the term “occlude” refers to any impediment of the egress of the unused pharmaceutical and/or bentonite clay from the container.

### Embodiments of the Invention

In one embodiment of the invention sodium bentonite clay is affixed between two substrates which are permeable to water and ethanol. The bentonite affixed between the substrates is then placed in a pouch containing a tongue and groove seal that is impermeable to water. The pouch itself is then hermetically sealed above the tongue and groove seal and provided with a notch between the hermetic seal and tongue and groove seal such that the end user may easily remove the hermetic seal.

In another embodiment sodium bentonite clay is affixed between two substrates which are permeable to water and ethanol. The bentonite affixed between the substrates is placed in a plastic bottle which is then capped with a screw-type lid that may be removed and reattached by the end user.

In yet another embodiment, the bentonite clay is affixed to one side of a substrate between two halves of a tongue and groove seal. The substrate is then sealed on three sides forming a pouch with an opening comprising a tongue and groove seal wherein the bentonite clay disposed therein. The pouch is then hermetically sealed above the tongue and groove seal and provided with a notch between the hermetic seal and tongue and groove seal such that the end user may easily remove the hermetic seal.

### EXAMPLES

### Example 1—Bentonite is Effective to Inhibit Extraction of Fentanyl at Room Temperature Methods

Two sprays of a fentanyl spray (0.8 milligrams (“mg”) per spray) were actuated into two containers containing 1 gram of bentonite each. The containers were capped and shaken. Following shaking, a volume of water or ethanol (“EtOH”) was added to the containers at room temperature and shaken for three minutes. The contents of the containers were then centrifuged and the supernatant was filtered through a 0.45 μM syringe filter. The filtered supernatant was analyzed using high pressure liquid chromatography (“HPLC”) analysis.

### Results

TABLE 1
Extraction of Fentanyl at Room Temperature

Solvent

| | Water | EtOH |
|---|---|---|
| Amount of Fentanyl Sprayed (mg) | 1.6 | 1.6 |
| Amount of Fentanyl Recovered (mg) | 0.026 | 0.052 |
| % Recovered | 1.625% | 3.25% |

As demonstrated in Table 1 bentonite was surprisingly effective at preventing extraction of fentanyl using the common household solvents, water and ethanol, at room temperature. Further, the amount of water or ethanol used in the extraction diluted the fentanyl to a sub-effective concentration.

### Example 2—Bentonite is Effective to Inhibit Extraction of Fentanyl Methods

Two sprays of a fentanyl spray (800 mcg per spray) were actuated into four containers containing 1 gram of bentonite each. The container was capped and shaken. Following shaking, a volume of water, EtOH or 70% isopropyl alcohol (“IPA”) was added to the container and shaken for three minutes. Two containers were then placed at room temperature for 10 minutes. The other two containers were placed in a 70° C. water bath for 10 minutes and then cooled to room temperature. The contents of the containers were then centrifuged and the supernatant was filtered through a 0.45 μM syringe filter. The filtered supernatant was measured for volume and then analyzed using high pass liquid chromatography (“HPLC”) analysis.

### Results

TABLE 2
Extraction of Fentanyl at Room Temperature and 70° C.

| | Solvent | | | | | |
|---|---|---|---|---|---|---|
| | Water | EtOH | IPA | Water | EtOH | IPA |
| | (RT) | (RT) | (RT) | (70° C.) | (70° C.) | (70° C.) |
| Fentanyl | 1.6 | 1.6 | 1.6 | 1.6 | 1.6 | 1.6 |
| Sprayed (mg) | | | | | | |
| Fentanyl | 0.002 | 0.03 | 0.002 | 0.002 | 0.072 | 0.028 |
| Recovered (mg) | | | | | | |
| % Recovered | 0.125 | 1.875 | 0.125 | 0.125 | 4.5 | 1.75 |

As demonstrated in Table 2 bentonite was surprisingly effective at preventing extraction of fentanyl using the common household solvents, water, ethanol and 70% isopropyl alcohol, at both room temperature and 70° C.

What is claimed is:

1. A disposal system for unused portions of a liquid fentanyl spray comprising:
(a) a pouch comprising an opening and a tongue and groove seal to occlude the opening;
and
(b) bentonite clay disposed in the pouch,
wherein the bentonite clay is affixed between a first substrate and a second substrate and wherein the bentonite clay comprises sodium bentonite.

3. The disposal system of claim 1, wherein sawdust is not disposed in the pouch.

4. The disposal system of claim 1, wherein the first substrate and the second substrate are water and ethanol permeable.

5. A method of disposing of unused portions of a liquid fentanyl spray device comprising the steps of:
(i) actuating the liquid fentanyl spray device wherein the spray stream passes through an opening of a pouch and contacts bentonite clay disposed in the pouch; and
(ii) occluding the opening of the pouch with a tongue and groove seal,
wherein the bentonite clay is affixed between a first substrate and a second substrate and wherein the bentonite clay comprises sodium bentonite and wherein the bentonite clay comprises sodium bentonite.

6. The method of claim 5, wherein sawdust is not disposed in the pouch.

7. The method of claim 5, wherein the one or more substrates are water and ethanol permeable.
